(19) United States
(12) Patent Application Publication
(10) Pub. No.: US 2009/0171571 A1
(43) Pub. Date: Jul. 2, 2009

(54) Navigation system and method using visible light communication

(75) Inventors: Jae-Seung Son, Suwon-si (KR); Eun-Tae Won, Seoul (KR); Jong-Hoon Ann, Suwon-si (KR); Tae-Han Bae, Seongnam-si (KR); Seung-Hoon Park, Seoul (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 12/319,054

(22) Filed: Dec. 31, 2008

(30) Foreign Application Priority Data
Dec. 31, 2007 (KR) 10-2007-0141735

(51) Int. Cl. G01C 21/00; H04B 10/00

(52) U.S. Cl. 701/208; 398/130

(57) ABSTRACT

A system and method for providing an in-building navigation service using VLC are provided, in which transmitters control lamp modules to generate visible light signals each in a combination of different wavelengths as information for a navigation function, a mobile terminal receives visible light signals from a plurality of lamp modules that illuminate an area where the mobile terminal is located, location information about a current location of the mobile terminal is acquired through the visible light signals received from the plurality of lamp modules, and navigation information including information that matches the location information to map information is displayed on the mobile terminal.

### CLAIM OF PRIORITY

This application claims the benefit of the earlier filing date, under 35 U.S.C. §119(a), to that Korean Patent Application filed in the Korean Intellectual Property Office on Dec. 31, 2007 and assigned Serial No. 10-2007-141735, the entire disclosure of which is hereby incorporated by reference.

### BACKGROUND OF THE INVENTION

1. Field of the Invention

The present invention generally relates to a navigation system and more particularly a system and method for providing a navigation service within a building by Visible Light Communication (VLC).

2. Description of the Related Art

The Korean Agency for Technology and Standards (KATS) announced that traditional lighting would be replaced by Light Emitting Diodes (LEDs) by 2015. Due to their high luminous efficiency and low price, LEDs are gaining popularity in general illumination applications that have been dominated by fluorescence and incandescence as well as in special illumination applications with regard to portable devices, cars, displays, traffic signals, and advertising boards. Also, Radio Frequency (RF) exhaustion, probable incompatibility between wireless communication technologies, increasing communication security requirements, and the advent of an ultra high-speed ubiquitous communication environment of 4^{th} Generation (4G) wireless technology are driving forces behind the recent increasing interest in visible light wireless communication technology that is mutually complementary to existing RF technologies. Therefore, many companies and research institutes are conducting studies on VLC wireless communications using visible light LEDs.

In the nature of delivering information by visible light detectable to the human eye, VLC is safe, has a wide range of usage bands, and offers freedom of operation without significant restrictions. In addition, as the user can view the destination and direction of light, he can determine the reception range of information. Owing to the resulting reliability in terms of security and low-power consumption, VLC is applicable to hospitals and airplanes where the use of RF technologies is restricted and enables provisioning of an additional information service with the aid of an electronic bulletin board.

FIG. 1A illustrates the configuration of a conventional VLC communication system. Referring to FIG. 1A, the conventional VLC communication system includes a plurality of lamps represented as lamps 101, 102 and 103. Lamps 101, 102 and 103 may be any type of visible light source but for the purposes of describing the invention herein, lamps 101, 103 and 103 represent LEDs or Laser Diodes (LDs), for serving as light sources for transmitting data by visible light. Communication devices 120 and 121 each having a VLC transceiver, for transmitting and receiving data to and from the lamps 101, 102 and 103. The communication devices 120 and 121 can be a mobile terminal 120, such as a Personal Digital Assistant (PDA) and/or a fixed terminal 121, such as a desktop/laptop computer.

FIG. 1B illustrates a peripheral interface system using a VLC system. Referring to FIG. 1B, VLC communication between peripheral devices refers to communications based on visible light among peripheral devices including, for example, a communication device 130 equipped with a VLC transceiver, such as a laptop or a desktop, a portable mobile device 131, such as a hand-held phone or a PDA, a peripheral device 132, such as a printer or a scanner, and a small-size digital product, such as a digital camera or an MP3 player (not shown). The VLC-based peripheral interface guarantees security and can be realized with low power.

In addition, a VLC system can be more efficient in combination with a communication system using any other type of wired/wireless communication medium. A VLC communication system for providing information by visible light within a building in conjunction with Power Line Communication (PLC) using a power line will be described in detail.

FIGS. 2A and 2B illustrate the configurations of conventional PLC-VLC communication systems. FIG. 2A illustrates a system for broadcasting music information to a user in a PLC-VLC communication system.

Referring to FIG. 2A, the PLC-VLC communication system includes a music server 201 for storing data to be provided to users, a power line 202 for PLC between the music server 201 and a lamp 203, the lamp 203 for receiving the data from the music server by PLC and transmitting the data in a visible light signal, and a mobile terminal 131 for receiving the visible light signal from the lamp 203. The mobile terminal may be in direct (wired) or indirect (wireless) communication with a speaker (not shown) or headset (shown) system for the playback of the data provided by the music server 201.

In operation, the music server 201 transmits data to the lamp 203 by PLC with the aid of the power line 202. The lamp 203 modulates the received data to a visible light signal by use of an LED and broadcasts the visible light signal. The mobile terminal 131 can convert the visible light signal received from the lamp 203 to an electrical signal.

FIG. 2B illustrates a conventional system for broadcasting video information to a user in the PLC-VLC communication system. Referring to FIG. 2B, the system is similar to that illustrated in FIG. 2A in configuration and operation, except for the use of a video server 205 for storing video/audio information. Users can receive information from a server 205 by VLC at any place where there are lights in the VLC communication system.

Meanwhile, mobile terminals such as portable phones, Personal Communication Services (PCSs), International Mobile Telecommunications-2000 (IMT-2000) phones, and PDAs have recently been equipped with various convenient functions including message transmission/reception, wireless Internet browsing, scheduling management, and navigation beyond the traditional voice call.

One of the convenient functions, Global Positioning System (GPS)-based navigation, is the function of receiving information about a path to an intended destination entered by a user from a navigation system and notifying the user of an optimum path and direction. Typically, the navigation function is designed so as to indicate the current location of a vehicle. Hence, an in-vehicle navigation system itself can search for the optimum path based on map data stored in a database.

Evolving from the in-vehicle navigation system, a navigation system is under development that can provide a navigation service to pedestrians through a navigation device, such as a mobile terminal, when they are in a crowded downtown area or visiting unfamiliar destinations. Such a navigation device for pedestrians would indicate an optimum path to a destination to a user and enables the user to monitor the optimum path.

However, when the pedestrian enters a building or goes down into the underground, the conventional GPS-based navigation cannot provide the navigation service due to non-reception of GPS signals.

Accordingly, there exists an increasing need for in-building navigation along with the trend of increasing large-scale buildings including skyscrapers, large shopping malls, and large underground arcades.

### SUMMARY OF THE INVENTION

An aspect of exemplary embodiments of the present invention is to provide a navigation method and apparatus for enabling a user to easily find out his destination within a skyscraper, a large building or when GPS navigation signals are not available.

Another aspect of exemplary embodiments of the present invention provides a navigation method and apparatus for preventing interference between signals generated from lamp modules that illuminate the same area by combining light in different wavelengths according to chromaticity diagrams.

A further aspect of exemplary embodiments of the present invention provides a navigation method and apparatus for using interference-free lamp modules so that a mobile terminal can receive visible light signals simultaneously from a plurality of lamp modules and for measuring the locations of the mobile terminal accurately.

In accordance with an aspect of exemplary embodiments of the present invention, there is provided an in-building navigation method using a VLC system, in which transmitters control lamp modules to generate visible light signals each in a combination of different wavelengths as information for a navigation function, a mobile terminal receives visible light signals from a plurality of lamp modules that illuminate an area where the mobile terminal is located, location information about a current location of the mobile terminal is acquired by the visible light signals received from the plurality of lamp modules, and navigation information including information that matches the location information to map information that is displayed on the mobile terminal.

The map information may include an in-building map information including the floor plan of each floor and locations and IDs of the lamp modules.

The lamp modules communicate with a navigation server by PLC using a power line as a medium and each of the lamp modules has a VLC transmitter for communicating with the mobile terminal by VLC.

In addition, the transmitters transmit synchronized pilot signals.

For acquisition of the location information, the mobile terminal calculates times to receive the pilot signals from the lamp modules and transmits the calculated times to a navigation server, and the navigation server calculates the location of the mobile terminal, taking into account the calculated times. For example, a time of transmission may be included within the information and a difference in time of transmission and time of reception may be determined. In another aspect, the pilot tones may be transmitted on a periodic basis and a difference may then be determined from the receipt of one or more of the periodically transmitted pilot tones.

The current location of the mobile terminal can be calculated based on information about identifications (IDs) and locations of the lamp modules included in the visible light signals.

The navigation server transmits the navigation information including information that matches the location information calculated by the navigation server to map information to the transmitters, the transmitters transmit the navigation information to the mobile terminal through the lamp modules, and the mobile terminal displays the navigation information.

For acquisition of the location information, the time taken to receive a pilot signal at the mobile terminal from each of the lamp modules is stored, and the stored time and a time taken to receive a previous pilot signal from the each lamp module are averaged.

The transmitters can transmit the synchronized pilot signals together with identifications (IDs) of the transmitters.

For acquisition of the location information, the mobile terminal can calculate times taken to receive the pilot signals from the lamp modules, and calculate the current location of the mobile terminal, taking into account the times and the IDs of the transmitters.

It is preferred to calculate the current location of the mobile terminal based on information about IDs and locations of the lamp modules in the received visible light signals.

The navigation information including information that matches the location information calculated by the mobile terminal to the map information is generated and displayed.

For acquisition of the location information, the time taken to receive a pilot signal from each of the lamp modules at the mobile terminal can be stored and the stored time and a time taken to receive a previous pilot signal from the each lamp module can be averaged.

It is preferred that each of the lamp modules emits a visible light signal by combining at least one red light, at least one green light, and at least one blue light.

At least one of the red light, the green light, and the blue light that are combined to form a visible light signal in a lamp module has the luminance and light intensity of a different wavelength from a color visible light corresponding to the at least one color light in a neighbor lamp module.

It is preferred that the plurality of lamp modules is arranged so that adjacent lamp modules emit different visible light signals. The number of the plurality of lamp modules can be at least 4.

In accordance with another aspect of exemplary embodiments of the present invention, there is provided an in-building navigation system using a VLC system in which a navigation server stores map information including map images to provide a navigation function and transmits navigation information including location information and the map information, a plurality of lamp modules generate visible light signals each in a combination of different wavelengths, a plurality of transmitters are connected between the navigation server and the plurality of lamp modules and transmit VLC signals and the navigation information received from the navigation server to the lamp modules, and a mobile terminal has a VLC receiver for receiving and identifying the visible light signals from the lamp modules and receives and displays the navigation information. The navigation server acquires the location information based on distances between the mobile terminal and the plurality of lamp modules.

The map information includes an in-building map information including a floor plan of each floor and locations and identifications (IDs) of the lamp modules with respect to a corresponding floor or with respect to the building.

The transmitters can communicate with the navigation server by PLC using a power line as a medium and can communicate with the mobile terminal by VLC through the lamp modules.

The transmitters transmit synchronized pilot signals through the lamp modules, the mobile terminal calculates a time taken to receive the pilot signal from corresponding lamp modules and transmits the calculated times to the navigation server, and the navigation server calculates the location information of the mobile terminal, taking into account the calculated times (and the corresponding lamp modules).

It is preferred that the location of the mobile terminal is calculated based on information about IDs and locations of the lamp modules included in the visible light signals received by the mobile terminal.

Each of the lamp modules can emit a visible light signal by combining at least one red light, at least one green light, and at least one blue light.

It is preferred that at least one of the red light, the green light, and the blue light that are combined to form a visible light signal in a lamp module has the luminance and light intensity of a different wavelength from a color visible light corresponding to the at least one color light in a neighbor lamp module.

It is preferred that the plurality of lamp modules are arranged so that adjacent lamp modules emit different visible light signals and the number of the plurality of lamp modules is at least 4.

The VLC receiver may include a plurality of optical filters for passing color visible lights generated by combining luminance and light intensities of different wavelengths, a plurality of opto-electric devices connected to the plurality of optical filters, for converting optical signals passing through the optical filters to electrical signals, and a plurality of signal converters for converting the electrical signals to bit signals.

In accordance with a further aspect of exemplary embodiments of the present invention, there is provided an in-building navigation system using VLC, in which a navigation server stores map information including map images to provide a navigation function, a plurality of lamp modules generate visible light signals each in a combination of different wavelengths, a plurality of transmitters are connected between the navigation server and the plurality of lamp modules and transmit VLC signals to the lamp modules, and a mobile terminal has a VLC receiver for receiving and identifying the visible light signals from the lamp modules, acquires location information based on times taken to receive the visible light signals from the lamp modules, generates navigation information including the location information and the map information received from the navigation server, and displays the navigation information.

### BRIEF DESCRIPTION OF THE DRAWINGS

The above features and advantages of certain exemplary embodiments of the present invention will be more apparent from the following detailed description taken in conjunction with the accompanying drawings, in which:

FIGS. 1A and 1B illustrate the configuration of a conventional VLC communication system;

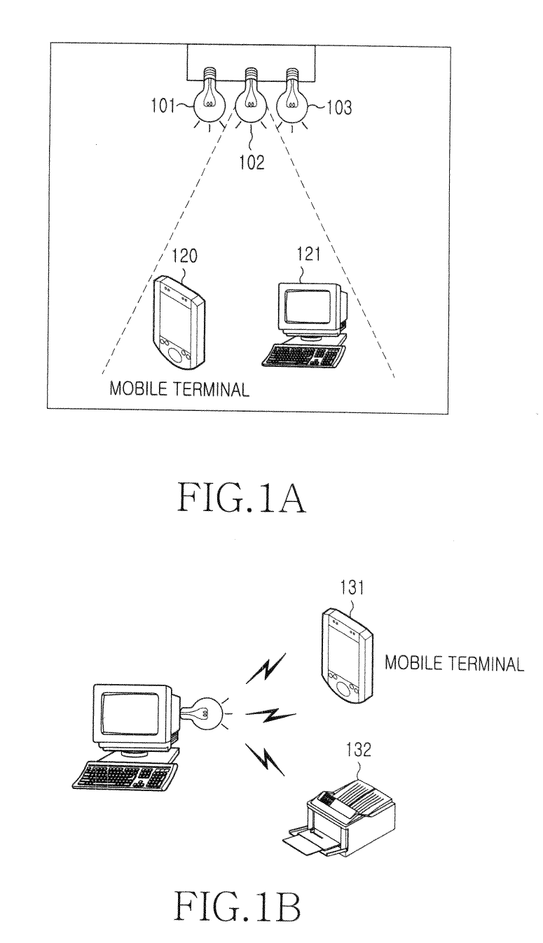

FIGS. 2A and 2B illustrate the configurations of conventional PLC-VLC communication systems;

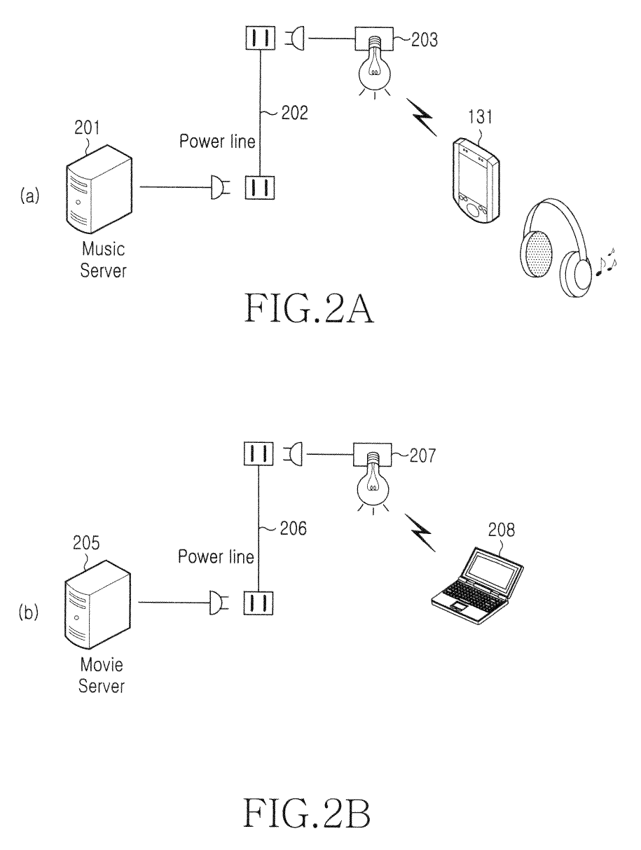

FIG. 3 illustrates the configuration of a navigation system according to an exemplary embodiment of the present invention;

FIG. 4 illustrates an exemplary chromaticity diagram compliant with the standard for color specification and measurement developed by the Commission Internationale del'Eclairage (CIE);

FIG. 5 is a block diagram of a first lamp module in the navigation system according to an exemplary embodiment of the present invention;

FIG. 6 is an exemplary chromaticity diagram representing colors generated from the first lamp module illustrated in FIG. 5;

FIG. 7 is a block diagram of a second lamp module in the navigation system according to an exemplary embodiment of the present invention;

FIG. 8 is an exemplary chromaticity diagram representing colors generated from the second lamp module illustrated in FIG. 7;

FIG. 9 is a block diagram of a third lamp module in the navigation system according to an exemplary embodiment of the present invention;

FIG. 10 is an exemplary chromaticity diagram representing colors generated from the third lamp module illustrated in FIG. 9;

FIG. 11 is a block diagram of a fourth lamp module in the navigation system according to an exemplary embodiment of the present invention;

FIG. 12 is an exemplary chromaticity diagram representing colors generated from the fourth lamp module illustrated in FIG. 11;

FIG. 13 illustrates a layout of lamp modules and the coverage of the lamp modules in the navigation system according to an exemplary embodiment of the present invention;

FIG. 14 illustrates the configuration of a VLC receiver in a mobile terminal in the navigation system according to an exemplary embodiment of the present invention;

FIG. 15 illustrates an exemplary screen display in the mobile terminal during navigation according to an exemplary embodiment of the present invention;

FIG. 16 is a flowchart illustrating a navigation method according to an exemplary embodiment of the present invention; and

FIG. 17 is a flowchart illustrating a navigation method according to another exemplary embodiment of the present invention.

Throughout the drawings, the same drawing reference numerals will be understood to refer to the same elements, features and structures.

### DETAILED DESCRIPTION OF THE INVENTION

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention are intended to provide a navigation function within a large building such as a skyscraper or a large shopping mall by a VLC system using visible light as a communication medium. The conventional GPS-based navigation system has the shortcoming that the navigation function is not available in a non-GPS reception area (e.g., inside a building). To avert this problem, the present invention designs a navigation system using VLC, not GPS. Visible light emitted from individual light fixtures within a building have limits in their reach. In other words, a light fixture inside a building illuminates a predetermined fixed area after it is installed within the building. In this context, an overall in-building map is acquired such that light fixtures within a building may be located, and Identifiers (IDs) are allocated to the light fixtures, so that a mobile terminal can locate itself by checking the ID of a light fixture from which the mobile terminal is receiving visible light.

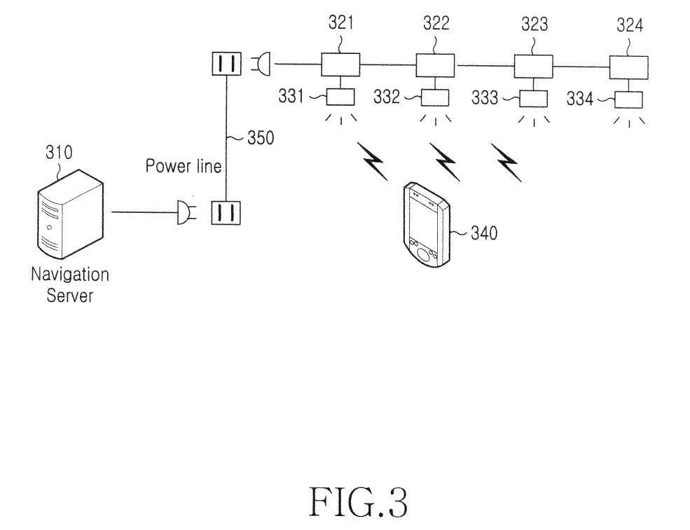

FIG. 3 illustrates the configuration of a navigation system according to an exemplary embodiment of the present invention. Referring to FIG. 3, the navigation system includes a navigation server 310, VLC transmitters 321 to 324 and corresponding lamp modules 331 to 334. The mobile terminal 340 may receive light generated by one or more of the lamp modules 331-334.

The navigation server 310 stores necessary data (audio, video, audio/visual) for providing a navigation function. The mobile terminal 340 cannot store all in-building information due to its limited memory capacity. Therefore, the navigation server 310 stores information such as in-building map data including the floor plan of each floor and data about the locations and IDs of the lamp modules 331 to 334.

The navigation server 310 can be connected to the VLC transmitters 321 to 324 by a power line 350. Preferably, the navigation server 310 communicates with the VLC transmitters 321 to 324 by PLC.

While data communication is carried out between the navigation server 310 and the VLC transmitters 321 to 324 by PLC, to which the present invention is not limited, the data communication can be performed in a general wired/wireless communication method, for example.

The VLC transmitters 321 to 324 convert data received from the navigation server 310 to a VLC protocol suitable for transmission via the lamp modules. When transmitting the VLC data, the VLC transmitters 321 to 324 can include their IDs in the data.

The lamp modules 331 to 334, which are installed all over the building, serve as sources of light and may also transmit the data received from the VLC transmitters 321 to 324 in the form of visible light signals as VLC devices.

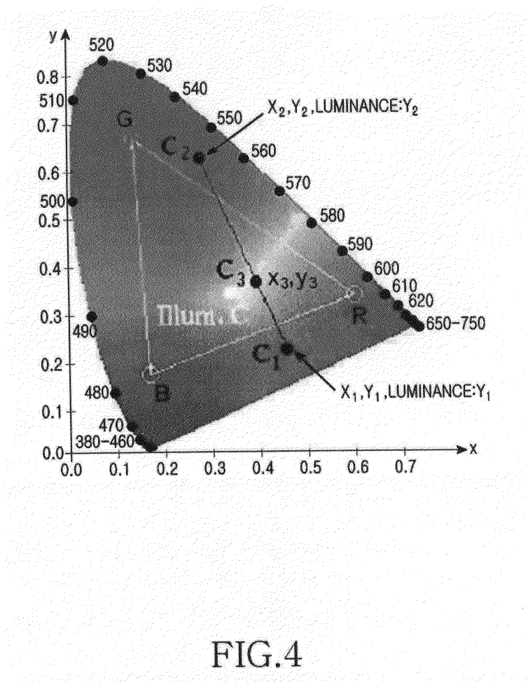

FIG. 4 illustrates an exemplary chromaticity diagram compliant with the standard for color specification and measurement developed by the Commission Internationale de l'Eclairage(CIE). [Color diagrams are not generally provided to the Patent Office because the printing is done in Black and white. Can you provide these diagrams with hatching to show different regions because the BW figures will not show the different colors.] Referring to FIG. 4, every color can be represented as a combination of chromaticities x and y and a light intensity (i.e. a measure of luminance) Y based on a measurement of a spectrophotometer. The light intensity is the amount of energy of light that reaches a unit area perpendicular to a light ray apart from a light source by a unit distance for a unit time. That is, red light R, green light G, and blue light B are defined as the chromaticities of the locations of predetermined points. Further, the color of a point, for example, C₃ can be generated by combining the colors of points C₁ and C₂. For example, the chromaticities of C₃ can be computed by

$${x}_{3} = \frac{{Y}_{1}}{{Y}_{1} + {Y}_{2}} {x}_{1} + \frac{{Y}_{2}}{{Y}_{1} + {Y}_{2}} {x}_{2} , {y}_{3} = \frac{{Y}_{1}}{{Y}_{1} + {Y}_{2}} {y}_{1} + \frac{{Y}_{2}}{{Y}_{1} + {Y}_{2}} {y}_{2} \qquad ( 1 )$$

where x₁ and y₁ are the coordinates of the point C₁,
   x₂ and y₂ are the coordinates of the point C₂, and
   Y₁ and Y₂ are the luminances of the points C₁ and C₂.

According to the chromaticity diagram, each of the lamp modules 331 to 334 may include lamps (e.g. Light Emitting Diodes (LEDs)) for emitting the red light R, the green light G, and the blue light B, respectively, and can generate light in a particular wavelength (e.g. white light) required for general lighting by using the LEDs in a known combination.

Furthermore, the lamp module can emit the red light R, the green light G, and the blue light B as single colors or combinations each of at least two colors.

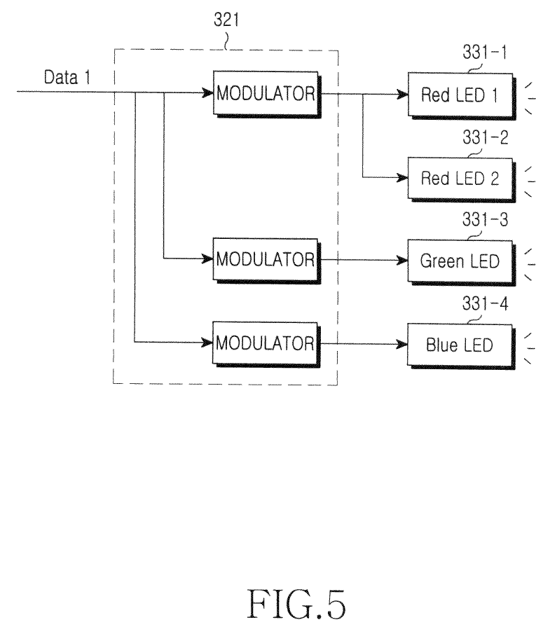

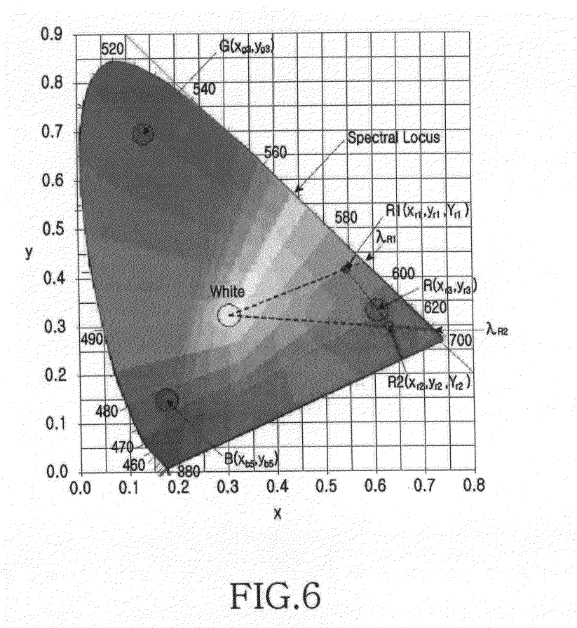

FIG. 5 is a block diagram of the first lamp module in the navigation system according to an exemplary embodiment of the present invention and FIG. 6 is an exemplary chromaticity diagram representing colors generated from the first lamp module illustrated in FIG. 5.

Referring to FIGS. 5 and 6, the first lamp module 331 includes first and second red LEDs 331-1 and 331-2, a green LED 331-3, and a blue LED 331-4. The first and second red LEDs 331-1 and 331-2, the green LED 331-3, and the blue LED 331-4 generate colors corresponding to points R1, R2, G and B, respectively, on FIG. 6. To be more specific, the first lamp module 331 emits white light by combining the colors of R(xᵣ₃, yᵣ₃), G(x_{g3}, y_{g3}), and B(x_{b5}, y_{b5}). Color R(xᵣ₃, yᵣ₃) can be created by the first and second red LEDs 331-1 and 331-2 that emit light in main wavelengths of λ_{R1} and λ_{R2}, respectively, as noted from FIG. 6. The main wavelengths of the first and second red LEDs 331-1 and 331-2 are wavelengths at which lines from White to particular chromaticities (points R1(xᵣ₁, yᵣ₁, Yᵣ₁) and R2(xᵣ₂, yᵣ₂, Yᵣ₂)) meet a spectral locus. It should be noted that a luminance ratio between the first and second red LEDs 331-1 and 331-2 needs to be kept constant in order to emit the light R(xᵣ₃, yᵣ₃) required for the white light. Therefore, light should be emitted by applying the luminance ratio α₁ between the first and second red LEDs 331-1 and 331-2 computed by equation (2) to the second red LED 331-2. That is, the second red LED 331-2 emits brighter light than the first red LED 331-1 by α₁.

$${α}_{1} = \frac{{x}_{r 1} - {x}_{r 3}}{{x}_{r 3} - {x}_{r 2}} \qquad ( 2 )$$

where xᵣ₁, xᵣ₂ and xᵣ₃ are the respective x coordinates of points R1, R2 and R.

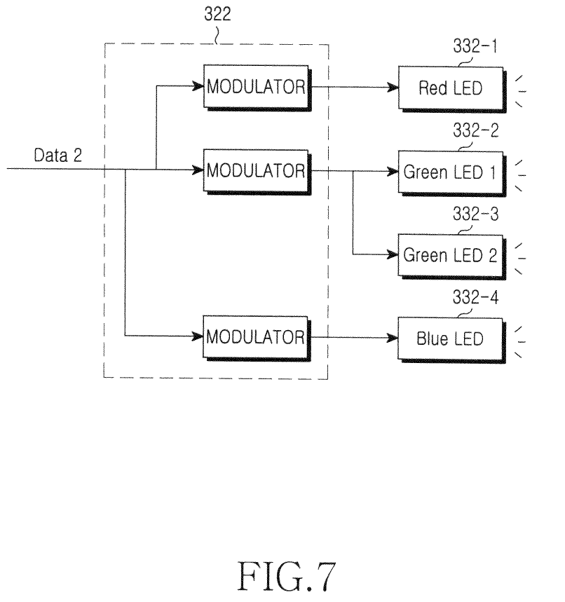

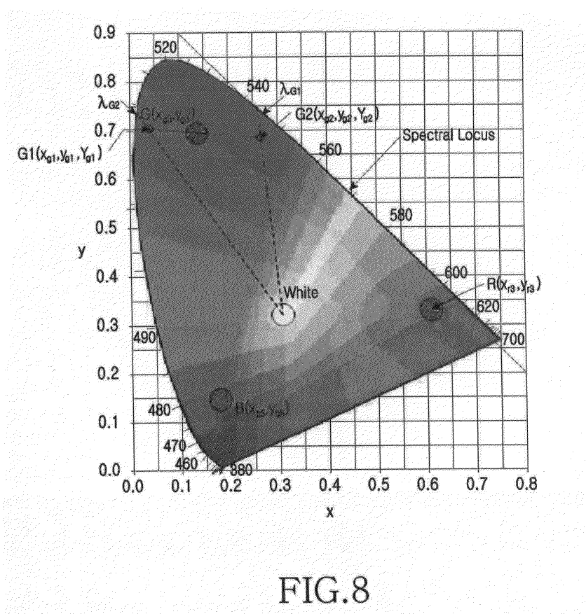

FIG. 7 is a block diagram of the second lamp module in the navigation system according to an exemplary embodiment of the present invention and FIG. 8 is an exemplary chromaticity diagram representing colors generated from the second lamp module illustrated in FIG. 7.

Referring to FIGS. 7 and 8, the second lamp module 332 includes a red LED 332-1, first and second green LEDs 332-2 and 332-3, and a blue LED 332-4. The red LED 332-1, the first and second green LEDs 332-2 and 332-3, and the blue LED 332-4 generate colors corresponding to points R, G1, G2 and B, respectively (FIG. 8). To be more specific, the second lamp module 332 emits white light by combining the colors of R(xᵣ₃, yᵣ₃), G(x_{g3}, y_{g3}), and B(x_{b5}, y_{b5}). G(x_{g3}, y_{g3}) can be created by the first and second green LEDs 332-2 and 332-3 that emit light in main wavelengths of λ_{G1} and λ_{G2}, respectively as noted from FIG. 8. The main wavelengths of the first and second green LEDs 332-2 and 332-3 are wavelengths at which lines from White to particular chromaticities (points G1(x_{g1}, y_{g1}, Y_{g1}) and G2(x_{g2}, Y_{g2}, Y_{g2})) meet a spectral locus. It should be noted that a luminance ratio between the first and second green LEDs 332-2 and 332-3 needs to be kept constant in order to emit the light G(x_{g3}, y_{g3}) required for the white light. Therefore, light should be emitted by applying the luminance ratio α₂ between the first and second green LEDs 332-2 and 332-3 computed by equation (3) to the second green LED 332-3. That is, the second green LED 332-3 emits brighter light than the first green LED 332-2 by α₂.

$${α}_{2} = \frac{{x}_{g 1} - {x}_{g 3}}{{x}_{g 3} - {x}_{g 2}} \qquad ( 3 )$$

where X_{g1}, x_{g2} and x_{g3} are the respective x coordinates of points G1, G2 and G.

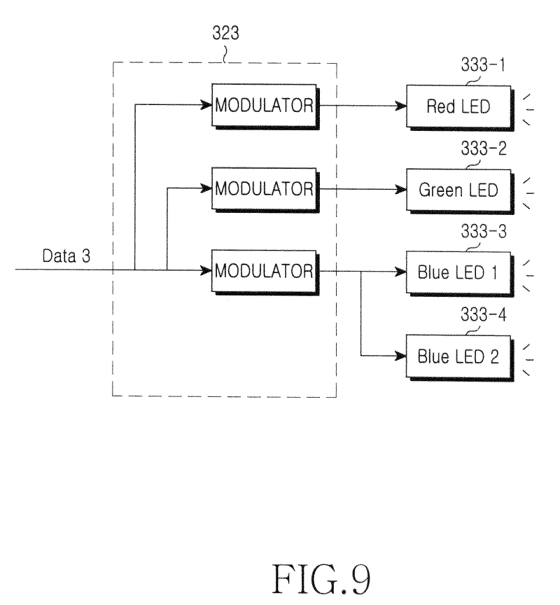

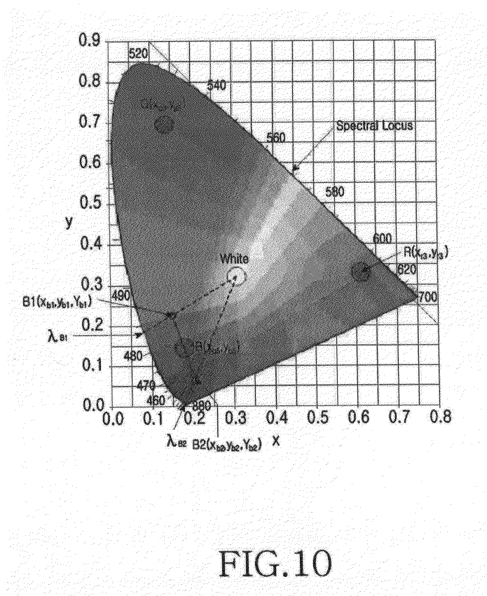

FIG. 9 is a block diagram of the third lamp module in the navigation system according to an exemplary embodiment of the present invention and FIG. 10 is an exemplary chromaticity diagram representing colors generated from the third lamp module illustrated in FIG. 9.

Referring to FIGS. 9 and 10, the third lamp module 333 includes a red LED 333-1, a green LED 333-2, and first and second blue LEDs 333-3 and 333-4. The red LED 333-1, the green LED 333-2, and the first and second blue LEDs 333-3 and 333-4 generate colors corresponding to points R, G, B1 and B2, respectively. To be more specific, the third lamp module 333 emits white light by combining the colors of R(xᵣ₃, yᵣ₃), G(x_{g3}, y_{g3}), and B(x_{b5}, y_{b5}). Color B(x_{b5}, y_{b5}) can be created by the first and second blue LEDs 333-3 and 333-4 that emit light in main wavelengths of λ_{B1} and λ_{B2}, respectively as noted from FIG. 10. The main wavelengths of the first and second blue LEDs 333-3 and 333-4 are wavelengths at which lines from White to particular chromaticities (points B1(x_{b1}, y_{b1}, Y_{b1}) and B2(x_{b2}, y_{b2}, Y_{b2})) meet a spectral locus. It should be noted that a luminance ratio between the first and second blue LEDs 333-3 and 333-4 needs to be kept constant in order to emit the light B(x_{b5}, y_{b5}) required for the white light. Therefore, light should be emitted by applying the luminance ratio α₃ between the first and second blue LEDs 333-3 and 333-4 computed by equation (4) to the second blue LED 333-4. That is, the second blue LED 333-4 emits brighter light than the first blue LED 333-3 by α₃.

$${α}_{3} = \frac{{x}_{b 1} - {x}_{b 5}}{{x}_{b 5} - {x}_{b 2}} \qquad ( 4 )$$

where x_{b1}, x_{b2} and x_{b5} are the respective x coordinates of points B1, B2 and B.

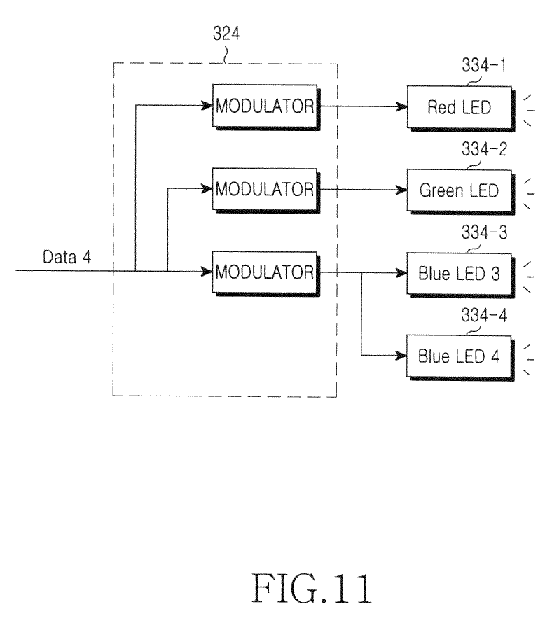

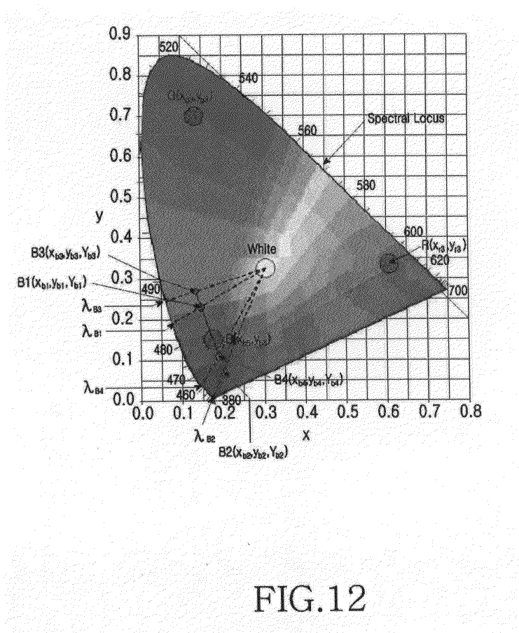

FIG. 11 is a block diagram of the fourth lamp module in the navigation system according to an exemplary embodiment of the present invention and FIG. 12 is an exemplary chromaticity diagram representing colors generated from the fourth lamp module illustrated in FIG. 11.

Referring to FIGS. 11 and 12, the fourth lamp module 334 includes a red LED 334-1, a green LED 334-2, and third and fourth blue LEDs 334-3 and 334-4. The red LED 334-1, the green LED 334-2, and the third and fourth blue LEDs 334-3 and 334-4 generate colors corresponding to points R, G, B3 and B4, respectively. To be more specific, the fourth lamp module 334 emits white light by combining the colors of R(xᵣ₃, yᵣ₃), G(x_{g3}, y_{g3}), and B(x_{b5}, y_{b5}). Color B(x_{b5}, y_{b5}) can be created by the third and fourth blue LEDs 334-3 and 334-4 that emit light in main wavelengths of λ_{B3} and λ_{B4}, respectively as noted from FIG. 12. The main wavelengths of the third and fourth blue LEDs 334-3 and 334-4 are wavelengths at which lines from White to particular chromaticities (points B3(x_{b3}, y_{b3}, Y_{b3}) and B4(x_{b4}, y_{b4}, Y_{b4})) meet a spectral locus. It should be noted that a luminance ratio between the third and fourth blue LEDs 334-3 and 334-4 needs to be kept constant in order to emit the light B(x_{b5}, y_{b5}) required for the white light. Therefore, light should be emitted by applying the luminance ratio α₄ between the third and fourth blue LEDs 334-3 and 334-4 computed by equation (5) to the fourth blue LED 334-4. That is, the fourth blue LED 334-4 emits brighter light than the third blue LED 334-3 by α₄.

$${α}_{4} = \frac{{x}_{b 3} - {x}_{b 5}}{{x}_{b 5} - {x}_{b 4}} \qquad ( 5 )$$

where x_{b3}, x_{b4} and x_{b5} are the respective x coordinates of points B3, B4 and B.

While each of the first to fourth lamp modules 331 to 334 is a combination of at least one red LED, at least one green LED, and at least one blue LED in the above exemplary embodiments of the present invention, to which the present invention is not limited, it is obvious that each lamp module may include other combination of the number of red, green and blue LEDs within the lamp module.

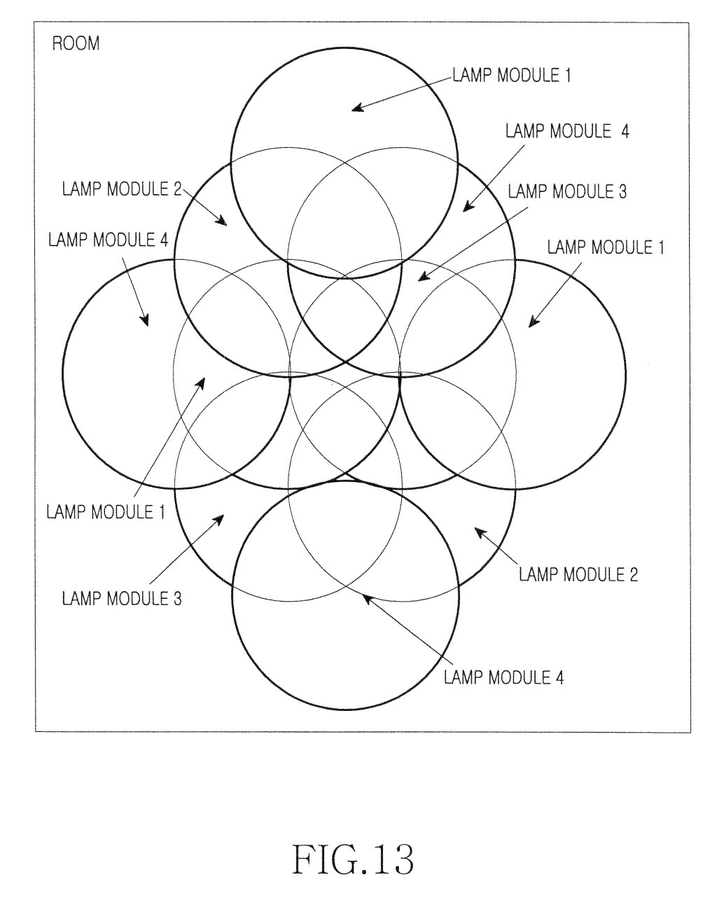

To avoid interference between visible light signals from adjacent lamp modules in the navigation system, at least four lamp modules, for example, the first to fourth lamp modules 331 to 334 are used. Also, as illustrated in FIG. 13, the lamps are arranged such that lamp modules of the same type do not emit visible light to the same area.

The mobile terminal 340, which may a portable mobile communication device equipped with a VLC receiver, performs VLC by receiving visible light signals from the lamp modules 331, 332, 333 and 334 and displays the current location and a map image based on navigation information received from the navigation server 310.

The VLC receiver is configured so as to separate signals received from the first to fourth lamp modules 331 to 334 each emitting visible light with a different combination of chromaticities and luminance.

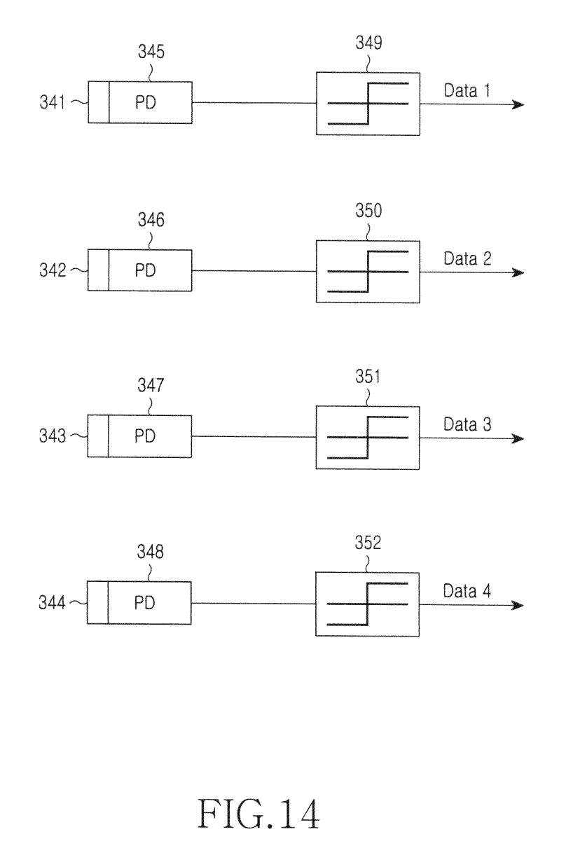

FIG. 14 illustrates the configuration of a VLC receiver in a mobile terminal in the navigation system according to an exemplary embodiment of the present invention.

Referring to FIG. 14, the VLC receiver includes first to fourth optical filters 341 to 344 for passing only visible light in predetermined different wavelengths to separate signals received from the first to fourth lamp modules 331 to 334.

For example, the first optical filter 341 passes visible light in main wavelengths emitted from the first and second red LEDs 331-1 and 331-2, the second optical filter 342 passes visible light in main wavelengths emitted from the first and second green LEDs 332-2 and 332-3, the third optical filter 343 passes visible light in wavelengths emitted from the first and second blue LEDs 333-3 and 333-4, and the fourth optical filter 344 passes visible light in main wavelengths emitted from the third and fourth blue LEDs 334-3 and 334-4.

The VLC receiver further includes opto-electric devices 345 to 348 and signal converters 349 to 352, which are connected to the first to fourth optical filters 341 to 344, respectively.

The opto-electric devices 345 to 348 convert optical signals received from the optical filters 341 to 344 to electrical signals. The opto-electric devices 345 to 348 can be Photo Diodes (PDs), for example. The signal converters 349 to 352 convert the signals received from the opto-electric devices 345 to 348 to bit signals.

The mobile terminal 340 receives signals (e.g. pilot signals) from the first to fourth lamp modules 331 to 334 and measures a time required to receive the pilot signals from each of the lamp modules

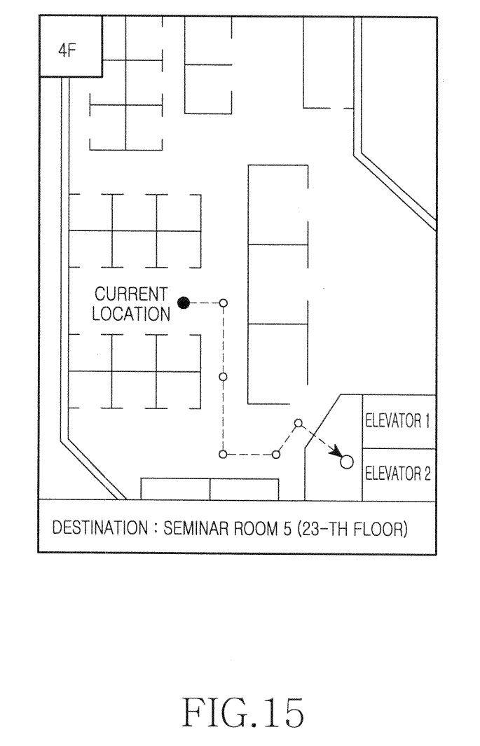

FIG. 15 illustrates an exemplary screen display in the mobile terminal during navigation according to an exemplary embodiment of the present invention. Referring to FIG. 15, the screen display provides information about the current location of a user and a path to a destination on the floor plan of a floor on which the user is. In addition, convenient functions may be added to the screen display, including zoom-in and zoom-out of a map, directions, and the time expected to the destination based on the speed of the pedestrian.

The mobile terminal 340 further includes a VLC transmitter for transmitting data about the computed times of receipt of pilot signals from corresponding lamp modules using a suitable VLC protocol to each of the first to fourth lamp modules 331 to 334. The first to fourth lamp modules 331 to 334 each may also further include a VLC receiver for receiving the signals from the VLC transmitter of the mobile terminal 340.

The VLC transmitter of the mobile terminal 340 can select one of the first to fourth lamp modules 331 to 334, for data transmission. That is, the VLC transmitter of the mobile terminal 340 generates a data packet having the times determined to receive the signals from each of the four lamp modules and transmits the data packet to a selected one of the first to fourth lamp modules 331 to 334 in a visible light signal of a wavelength corresponding to the selected lamp module. Alternatively, the VLC transmitter of the mobile terminal 340 generates four data packets having the times determined or computed to receive the signals, for example, the pilot signals, from the lamp modules and transmits the four data packets to at least one of the first to fourth lamp modules 331 to 334 in visible signals of wavelengths corresponding to the respective lamp modules 331 to 334.

In correspondence with the VLC transmitter of the mobile terminal 340, the lamp modules 331 to 334 and the VLC transmitters 321 to 324 each further include a VLC receiver. The VLC receivers of the VLC transmitters 321 to 324 can be configured in the same manner as that of the mobile terminal 340.

While the mobile terminal 340 transmits information about the times for receiving pilot signals through its VLC transmitter and the VLC receiver of a VLC transmitter receives the information in the exemplary embodiment of the present invention. In another aspect of the invention, the information transmission from the mobile terminal may be carried out by wireless RF communications such as Wireless LAN (Wi-Fi). That is, the mobile terminal 340 and the VLC transmitter may each be provided with an auxiliary communication device for supporting wireless RF communications such as Wi-Fi.

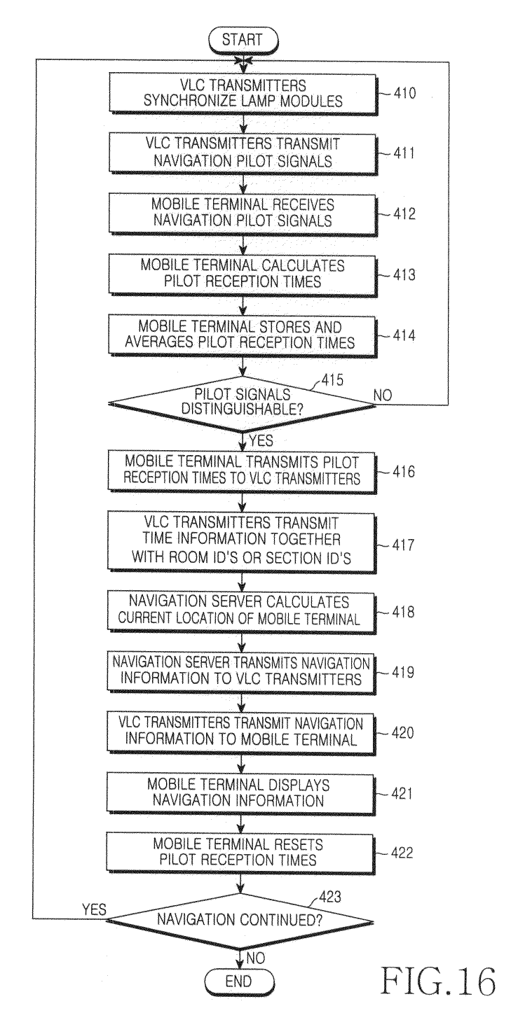

Now a description will be made of a navigation method according to an exemplary embodiment of the present invention. FIG. 16 is a flowchart illustrating the navigation method according to the exemplary embodiment of the present invention.

Referring to FIG. 16, when the navigation service process begins the navigation server 310 requests synchronization to a plurality of VLC transmitters 321 to 324 and the VLC transmitters 321 to 324 synchronize visible light signals emitted from the lamp modules 331 to 334 in step 410.

In step 411, the VLC transmitters 321 to 324 generate pilot signals for navigation through the lamp modules 331 to 334 according to the afore-mentioned chromaticity diagrams. That is, each lamp module emits visible light (e.g. white light) in a specific wavelength required for general lighting by use of the red, green, and blue LEDs of the lamp module in combination. Red, green, and blue lights each can be created in a single color or in a combination of two or more colors. For instance, the first to fourth lamp modules 331 to 334 illustrated in FIGS. 5 to 12 emit visible light signals having particular spectral characteristics.

The mobile terminal 340 receives the pilot signals from the first to fourth lamp modules 331 to 334 in step 412. The mobile terminal 340 separates the pilot signals through its VLC receiver. That is, the first optical filter 341 separates visible light in main wavelengths received from the first and second red LEDs 331-1 and 331-2, the second optical filter 342 separates visible light in main wavelengths received from the first and second green LEDs 332-2 and 332-3, the third optical filter 343 separates visible light in main wavelengths received from the first and second blue LEDs 333-3 and 333-4, and the fourth optical filter 344 separates visible light in main wavelengths received from the third and fourth blue LEDs 334-3 and 334-4 in the VLC receiver of the mobile terminal 340. The separated signals are transferred internally in the mobile terminal 340 through the opto-electric devices 345 to 348 and the signal converters 349 to 352 (FIG. 14).

In step 413, the mobile terminal 340 calculates a time taken to receive the pilot signal from each of the lamp modules 331 to 334 and generates time information indicating the calculated times. The mobile terminal 340 then stores the time information in a memory in step 414. When the pilot signals are received during an initial operation of the navigation system, the mobile terminal 340 stores the calculated times in the memory. In one aspect, if it is determined that there is no appreciable difference in the computed times of the receive new pilot signals from corresponding light sources then the mobile terminal 340 averages the computed times determined with regard to previously received pilot signals of the corresponding light source with the compute time of the received current pilot signals.

In the case where the mobile terminal 340 cannot calculate a time to receive the pilot signals because it is sufficiently spaced from at least one of the lamp modules 331 to 334 in step 415, it repeats steps 410 to 414.

In step 416, the mobile terminal 340 transmits the computed time information to at least one of the VLC transmitters 321 to 324.

Preferably, the mobile terminal 340 further includes a VLC transmitter for transmitting data by a VLC protocol and the VLC transmitters 321 to 324 each include a VLC receiver. Therefore, the mobile terminal 340 can transmit the time information to the VLC receivers of the VLC transmitters 321 to 324 through its VLC transmitter.

The VLC transmitters 321 to 324 transmit the collected time information together with their IDs to the navigation server 310 in step 417. The IDs of the VLC transmitters 321 to 324 can be allocated in a predetermined method so that the building, floors, rooms, and sections of the VLC transmitters 321 to 324 can be identified.

The navigation server 310 calculates the current location of the mobile terminal 340 by triangulation based on the computed time information and the IDs of the VLC transmitters 321 to 324 in step 418.

The navigation server 310 generates navigation information by matching the current location of the mobile terminal 340 to internally stored map information and transmits the navigation information to the VLC transmitters 321 to 324 in step 419.

Upon receipt of the navigation information, the VLC transmitters 321 to 324 generate data packets carrying the navigation information according to the VLC protocol and transmit the navigation information in the data packets to the mobile terminal 340 by a visible light emitted from each of the lamp modules 331 to 334 in step 420.

The mobile terminal 340 receives the data packets, extracts the navigation information from the VLC protocol-based data packets, and displays the navigation information in step 421.

To provide navigation information in relation to the current location of the mobile terminal 340, the current location of the mobile terminal 340 may be checked repeatedly. Therefore, the mobile terminal 340 resets the computed times required to receive pilot signals in step 422 and determines whether to receive navigation information continuously in step 423. If not receiving the navigation information any more, the mobile terminal 340 requests discontinuation of navigation information transmission to the navigation server 310 in step 424. On the other hand, if continuing to receive navigation information, the mobile terminal 340 requests the navigation server 310 to detect the current location of the mobile terminal 340. Then the navigation server 310, the VLC transmitters 321 to 324, the lamp modules 331 to 334, and the mobile terminal 340 repeat steps 410 to 422.

According to the above exemplary embodiment of the present invention, the navigation system and method involve the navigation server 310 and assumes the existence of downlink and uplink between the mobile terminal 340 and the navigation server 310. Especially, the navigation server 310 stores map information, receives time information about pilot signals from the mobile terminal 340, generates navigation information by matching map information to the current location of the mobile terminal 340, and transmits the navigation information to the mobile terminal 340.

While the mobile terminal 340 transmits the time information through its VLC transmitter to the VLC receivers of the VLC transmitters 321 to 324 in step 416, to which the present invention is not limited, it can be further contemplated that the mobile terminal 340 transmits the time information to the VLC transmitters 321 to 324 by wireless RF communications such as WiFi. That is, the mobile terminal 340 and the VLC transmitters 321 to 324 each may be provided with an auxiliary communication device for supporting wireless RF communications such as WiFi and the mobile terminal 340 transmits the time information through its auxiliary communication device to the auxiliary communication devices of the VLC transmitters 321 to 324.

A navigation system according to another exemplary embodiment of the present invention does not have uplinks from the mobile terminal 340 to the VLC transmitters 321 to 324.

Similar to the navigation system according to the first exemplary embodiment of the present invention, the navigation system according to the second exemplary embodiment of the present invention includes a navigation server 310, VLC transmitters 321 to 324, and corresponding lamp modules 331 to 334, except that the navigation server 310 receives no information form the mobile terminal 340. Hence, the navigation server 310 stores necessary data to provide a navigation function, for example, in-building map data including the floor plan of each floor, and the locations and IDs of the lamp modules 331 to 334.

In this second embodiment, the VLC transmitters 321 to 324 do not receive any information from the mobile terminal 340. They convert data received from the navigation server 310 to VLC format and transmit the data in VLC format to the mobile terminal 340 through the lamp modules 331 to 334, as previously discussed. Further, the VLC transmitters 321 to 324 transmit their IDs along with the VLC data to the mobile terminal 340. The IDs of the VLC transmitters 321 to 324 deliver identification information about the building, the floors, rooms, and sections of the VLC transmitters 321 to 324.

The lamp modules 331 to 334 operate in the same manner as in the first exemplary embodiment of the present invention.

The mobile terminal 340 is a portable mobile communication device equipped with a VLC receiver. Although the lamp modules 331 to 334 transmit downlink data to the mobile terminal 340, the mobile terminal 340 does not have uplinks to the lamp modules 331 to 334. Thus, the mobile terminal 340 receive all in-building information needed for navigation from the navigation server 310 and the VLC transmitters 321 to 324. For instance, the mobile terminal 340 receives in-building map information including the floor plans of the building from the navigation server 310 and receives the IDs of the lamp modules 331 to 334 and location information corresponding to the IDs from the VLC transmitters 321 to 324.

The mobile terminal 340 calculates times required to receive signals from the lamp modules 331 to 334 and determines its current location using the times and the locations of the lamp modules 331 to 334 using well-known triangulation methods. Then the mobile terminal 340 generates navigation information by matching the current location to the map information received from the navigation server 310 and displays the navigation information.

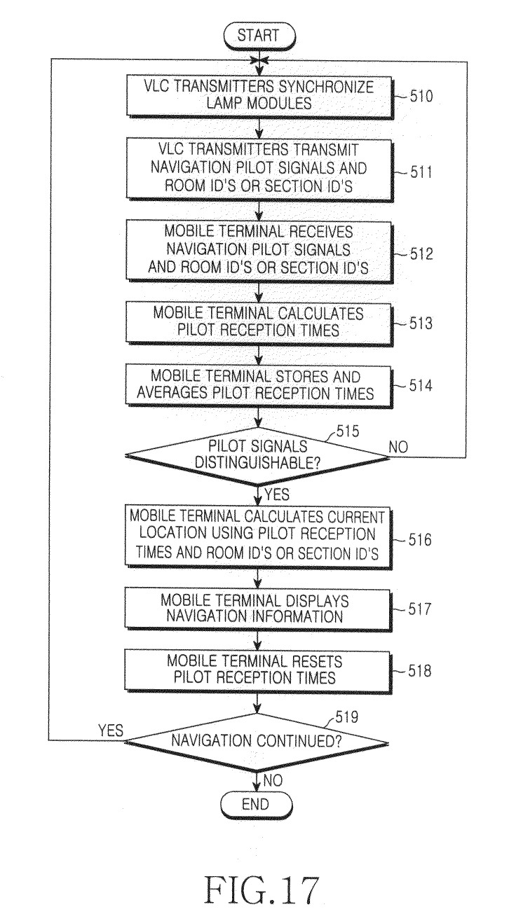

A description will be made of a navigation method in the navigation system according to the second exemplary embodiment of the present invention. FIG. 17 is a flowchart illustrating a navigation method according to the second exemplary embodiment of the present invention.

Referring to FIG. 17, when the navigation service starts, the navigation server 310 requests synchronization to the plurality of VLC transmitters 321 to 324 and the VLC transmitters 321 to 324 synchronize visible light signals emitted from the lamp modules 331 to 334 in step 510.

In step 511, the VLC transmitters 321 to 324 generate pilot signals for navigation and their IDs through the lamp modules 331 to 334 according to the afore-mentioned chromaticity diagrams. That is, each lamp module emits visible light (e.g. white light) in a specific wavelength required for general lighting by use of the red, green, and blue LEDs of the lamp module in combination. Red, green, and blue lights each can be created in a single color or in a combination of two or more colors. For instance, the first to fourth lamp modules 331 to 334 illustrated in FIGS. 5 to 12 emit visible light signals.

The mobile terminal 340 receives the pilot signals from the first to fourth lamp modules 331 to 334 in step 512. To be more specific, the mobile terminal 340 separates the pilot signals through its VLC receiver. That is, the first optical filter 341 separates visible light in main wavelengths received from the first and second red LEDs 331-1 and 331-2, the second optical filter 342 separates visible light in main wavelengths received from the first and second green LEDs 332-2 and 332-3, the third optical filter 343 separates visible light in main wavelengths received from the first and second blue LEDs 333-3 and 333-4, and the fourth optical filter 344 separates visible light in main wavelengths received from the third and fourth blue LEDs 334-3 and 334-4. The separated signals are transferred internally in the mobile terminal 340 through the opto-electric devices 345 to 348 and the signal converters 349 to 352.

In step 513, the mobile terminal 340 calculates a time to receive each of the pilot signals from a corresponding one of the lamp modules 331 to 334 and generates time information indicating the calculated times. The mobile terminal 340 then stores the time information in a memory in step 514. When the pilot signals are received during an initial operation of the navigation system, the mobile terminal 340 stores the calculated times in the memory. In addition, if new pilot signals are received and there is no significant distinction in the times between the newly received signals and previously received signals, the mobile terminal 340 averages the calculated times to receive previous pilot signals and the calculated times to receive the current pilot signals.

In the case where the mobile terminal 340 cannot calculate the times taken to receive the pilot signals because the mobile terminal is not sufficiently spaced from the lamp modules 331 to 334 in step 515, the mobile terminal repeats steps 510 to 514.

In step 516, the mobile terminal 340 calculates its current location by triangulation based on the time information and the locations of the VLC transmitters 321 to 324.

The mobile terminal 340 receives in-building map information including the floor plan of each floor and generates navigation information by matching the current location to the map information and displays the navigation information in step 517.

To provide navigation information in relation to the current location of the mobile terminal 340, the current location of the mobile terminal 340 may be checked repeatedly. Therefore, the mobile terminal 340 may reset the calculated times to receive pilot signals in step 518.

The mobile terminal 340 determines whether to continue the navigation in step 519. If the mobile terminal 340 does not continue the navigation, the mobile terminal 340 ends the procedure. Otherwise, if the mobile terminal 340 continues the navigation, it repeats steps 510 to 518.

The navigation server 310 stores the in-building map data including the floor plan of each floor due to the limited memory capacity of the mobile terminal 340 and the mobile terminal 340 receives the in-building map data from the navigation server 310 in the navigation system and method according to the second exemplary embodiment of the present invention.

However, in the case where the mobile terminal 340 has a sufficient memory capacity, it can store the in-building map data. In this case, the navigation server 310 stores only data about the locations and IDs of the lamp modules 331 to 334.

As is apparent from the above description, the present invention offers the following advantages.

(1) Navigation is available by VLC within a building where GPS signals cannot be received. Therefore, a destination can be easily detected in a skyscraper or a large building by the navigation function.

(2) No interference occurs between signals from lamp modules that illuminate the same area by combining light in different wavelengths according to chromaticity diagrams.

(3) Interference-free lamp modules are used. Therefore, a mobile terminal can receive visible light signals from a plurality of lamp modules and its location can be accurately determined.

(4) Use of room IDs or section IDs decreases the load of a header used for VLC.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein

While the invention has been shown and described with reference to certain exemplary embodiments of the present invention thereof, it will be understood by those skilled in the art that various changes in form and details may be made therein without departing from the spirit and scope of the present invention as defined by the appended claims and their equivalents.

What is claimed is:

1. An in-building navigation method using Visible Light Communication (VLC), comprising:
controlling each of a plurality of lamp modules to generate a visible light signal as information for a navigation function by transmitters, wherein said visible light generated by each of said plurality of lamp modules is formed from a combination of plurality of LED outputs to be different wavelength from adjacent ones of said lamp modules;
receiving said visible light signals from each of said plurality of lamp modules that illuminate an area where a mobile terminal is located by the mobile terminal;
acquiring location information regarding a current location of the mobile terminal by the visible light signals received from the plurality of lamp modules; and
displaying navigation information including information that matches the location information to map information on the mobile terminal.

2. The in-building navigation method of claim 1, wherein the map information includes in-building map information including the floor plan of each floor and locations and Identifiers (IDs) of the lamp modules.

3. The in-building navigation method of claim 1, wherein the lamp modules communicate with a navigation server by Power Line Communication (PLC) system using a power line as a medium and each of the lamp modules has a VLC transmitter for communicating with the mobile terminal by VLC.

4. The in-building navigation method of claim 1, wherein the controlling each of a plurality of lamp modules further comprises:
transmitting synchronized pilot signals through the transmitters.

5. The in-building navigation method of claim 4, wherein the location information acquisition comprises:
calculating times to receive the pilot signals from corresponding ones of the lamp modules by the mobile terminal;
transmitting the calculated times to a navigation server by the mobile terminal; and
calculating the location of the mobile terminal, taking into account the calculated times by the navigation server.

6. The in-building navigation method of claim 1, wherein the location information acquisition comprises:
calculating the current location of the mobile terminal based on information about IDs and locations of the lamp modules included in the visible light signals.

7. The in-building navigation method of claim 4, wherein the navigation information display comprises:
transmitting the navigation information including information that matches the location information calculated by the navigation server to map information to the transmitters by the navigation server;
transmitting the navigation information to the mobile terminal through the lamp modules by the transmitters; and
displaying the navigation information by the mobile terminal.

8. The in-building navigation method of claim 5, wherein the location information acquisition further comprises:
storing the calculated time to receive a pilot signal from each of the lamp modules at the mobile terminal; and
averaging the stored time and a time taken to receive a previous pilot signal from a corresponding one of the lamp modules.

9. The in-building navigation method of claim 1 wherein the controlling of the lamp modules comprises:
transmitting synchronized pilot signals and IDs of the transmitters through the transmitters.

10. The in-building navigation method of claim 9, wherein the location information acquisition comprises:
calculating times to receive the pilot signals from each of the lamp modules by the mobile terminal; and
calculating the current location of the mobile terminal, taking into account the times and the IDs of the transmitters by the mobile terminal.

11. The in-building navigation method of claim 10, wherein the location calculation comprises calculating the current location of the mobile terminal based on information about IDs and locations of the lamp modules in the received visible light signals by the mobile terminal.

12. The in-building navigation method of claim 10, wherein the navigation display comprises:
generating the navigation information including information that matches the location information calculated by the mobile terminal to the map information; and
displaying the navigation information.

13. The in-building navigation method of claim 10, wherein the location information acquisition further comprises:
storing the time taken to receive a pilot signal from each of the lamp modules at the mobile terminal; and
averaging the stored time and a time taken to receive a previous pilot signal from an corresponding one of the lamp modules.

14. The in-building navigation method of 1, wherein each of the lamp modules emits a visible light signal by combining at least one red light, at least one green light, and at least one blue light.

15. The in-building navigation method of claim 14, wherein at least one of the red light, the green light, and the blue light that are combined to form a visible light signal in a lamp module has the luminance and light intensity of a different wavelength from a color visible light corresponding to the at least one color light in a neighbor lamp module.

16. The in-building navigation method of claim 15, wherein the plurality of lamp modules are arranged so that adjacent lamp modules emit different visible light signals.

17. The in-building navigation method of claim 16, wherein the number of the plurality of lamp modules is at least 4.

18. An in-building navigation system using Visible Light Communication (VLC), comprising:
a navigation server for storing map information including map images to provide a navigation function and transmitting navigation information including location information and the map information;
a plurality of lamp modules for generating visible light signals each in a combination of different wavelengths;
a plurality of transmitters connected between the navigation server and the plurality of lamp modules, for transmitting signals and the navigation information received from the navigation server to the lamp modules in accordance with a VLC protocol; and
a mobile terminal having a VLC receiver for:
receiving and identifying the visible light signals from the lamp modules; and
receiving and displaying the navigation information,
wherein the navigation server acquires the location information based on distances between the mobile terminal and the plurality of lamp modules.

19. The in-building navigation system of claim 18, wherein the map information includes in-building map information including the floor plan of each floor and locations and Identifiers (IDs) of the lamp modules.

20. The in-building navigation system of claim 18, wherein the transmitters communicate with the navigation server by Power Line Communication (PLC) using a power line as a medium and communicate with the mobile terminal by VLC through the lamp modules.

21. The in-building navigation system of claims 18, wherein the transmitters transmit synchronized pilot signals through the lamp modules, the mobile terminal calculates times taken to receive the pilot signals from the lamp modules and transmits the calculated times to the navigation server, and the navigation server calculates the location information of the mobile terminal, taking into account the calculated times.

22. The in-building navigation system of claim 21, wherein the location of the mobile terminal is calculated based on information about IDs and locations of the lamp modules included in the visible light signals received by the mobile terminal.

23. The in-building navigation system of claim 21, wherein each of the lamp modules emits a visible light signal by combining at least one red light, at least one green light, and at least one blue light.

24. The in-building navigation system of claim 23, wherein at least one of the red light, the green light, and the blue light that are combined to form a visible light signal in a lamp module has the luminance and light intensity of a different wavelength from a color visible light corresponding to the at least one color light in a neighbor lamp module.

25. The in-building navigation system of claim 23, wherein the plurality of lamp modules are arranged so that adjacent lamp modules emit different visible light signals.

26. The in-building navigation system of claim 25, wherein the number of the plurality of lamp modules is at least 4.

27. The in-building navigation system of claim 23, wherein the VLC receiver comprises:
a plurality of optical filters for passing color visible lights generated by combining luminances and light intensities of different wavelengths;
a plurality of opto-electric devices connected to the plurality of optical filters, for converting optical signals passing through the optical filters to electrical signals; and
a plurality of signal converters for converting the electrical signals to bit signals.

28. An in-building navigation system using Visible Light Communication (VLC), comprising:
a navigation server for storing map information including map images to provide a navigation function;
a plurality of lamp modules for generating visible light signals each in a combination of different wavelengths;
a plurality of transmitters connected between the navigation server and the plurality of lamp modules, for transmitting VLC signals to the lamp modules; and
a mobile terminal having a VLC receiver for receiving and identifying the visible light signals from the lamp modules, for acquiring location information based on times to receive the visible light signals from the lamp modules, generating navigation information including the location information and the map information received from the navigation server, and displaying the navigation information.

29. The in-building navigation system of claim 28, wherein the transmitters transmit synchronized pilot signals through the lamp modules, the mobile terminal calculates the times to receive the pilot signals from the lamp modules and transmits the calculated times to the navigation server, and the navigation server calculates the location information of the mobile terminal, taking into account the calculated times.

30. The in-building navigation system of claim 28, wherein each of the lamp modules emits a visible light signal by combining at least one red light, at least one green light, and at least one blue light.

31. The in-building navigation system of claim 28, wherein at least one of the red light, the green light, and the blue light that are combined to a visible light signal in a lamp module has the luminance and light intensity of a different wavelength from a color visible light corresponding to the at least one color light in a neighbor lamp module.

32. The in-building navigation system of claim 28, wherein the plurality of lamp modules are arranged so that adjacent lamp modules emit different visible light signals.

33. The in-building navigation system of claim 32, wherein the number of the plurality of lamp modules is at least 4.

34. The in-building navigation system of claim 31, wherein the VLC receiver comprises:
a plurality of optical filters for passing color visible lights generated by combining luminances and light intensities of different wavelengths;
a plurality of opto-electric devices connected to the plurality of optical filters, for converting optical signals passing through the optical filters to electrical signals; and
a plurality of signal converters for converting the electrical signals to bit signals.

35. The in-building navigation system of claim 28, wherein the map information stored in the navigation server includes information about locations and Identifiers (IDs) of the lamp modules and the mobile terminal further comprises a memory for storing in-building map data including the floor plan of each floor.

36. The in-building navigation system of claim 28, wherein the map information stored in the navigation server includes information about locations and IDs of the lamp modules and the mobile terminal has in-building map data including the floor plan of each floor.

37. A VLC system unit comprising;
a PLC receiving unit;
a plurality of at least one of a red LED, a blue LED and a green LED;
a VLC transmitter unit, and
a processor in communication with a memory, the memory including code which when accessed by the processor causes the processor to:
receive control information through said PLC receiving unit;
apply said control information to each of said plurality of at least one red LED, blue LED and green LED to generate a visible light of a known wavelength; and
transmit via said VLC transmitter unit, on said generated visible light, at least one of: identification information associated with said VCL communication unit and time information.

38. The VLC system unit of claim 37, further comprising:
a receiver unit;
a PLC transmitting unit; wherein
said processor accesses code for:
receiving information via said receiver unit; and
formatting said information for transmission via said PLC transmitting unit.

39. The VLC system unit of claim 38, wherein said receiving unit is one selected from the group consisting of: VLC, wired, and wireless.

40. The VLC system unit of claim 37, wherein said processor further accesses said code to:
format said at least one of: identification information associated with said VCL communication unit and time information into a VLC format.

41. The VLC system unit of claim 37, wherein said processor further accesses said code to:
receive map information via said PLC receiver; and
transmit on said generated visible light, via said VLC transmitter unit, said map information.

42. The VLC system unit of claim 38 wherein said processor further accesses said code to:
receiving time difference information via said receiver; and
transmit said time difference information via as PLC transmitter.

43. A VLC system mobile terminal comprising:
a transmitting unit;
a VLC receiving unit for receiving a visible light transmission;
a plurality of filters for filtering said visible light transmission, said filtering distinguishing visible light transmission received from a plurality of sources; and
a processor in communication with a memory, said memory including code which when accessed by said processor causes said processor to:
determining an identification of each of said distinguished visible light transmissions;
determining a time of reception of each of said visible light transmissions;
calculating a time taken to receive each of said visible light transmissions; and
transmitting said calculated time taken via said transmitting unit.

44. The mobile terminal of claim 43, wherein said transmitting unit is one selected from the group consisting of: VLC, wired, and wireless.
